(19) United States
(12) Patent Application Publication
(10) Pub. No.: US 2026/0113215 A1
(43) Pub. Date: Apr. 23, 2026

(54) TRACKING REFERENCE SIGNAL REUSE FOR CHANNEL ESTIMATION

(71) Applicant: QUALCOMM Incorporated, San Diego, CA (US)

(72) Inventors: Jing LEI, San Diego, CA (US); Jing SUN, San Diego, CA (US)

(21) Appl. No.: 18/918,895

(22) Filed: Oct. 17, 2024

(51) Int. Cl. H04L 25/02; H04L 5/00

(52) U.S. Cl. CPC H04L 25/0224; H04L 5/0051

(57) ABSTRACT

Methods, systems, and devices for wireless communications are described. A network entity may transmit, and a UE may receive, an indication to reuse a tracking reference signal (TRS) for channel estimation of a downlink channel and an indication of a demodulation reference signal (DMRS) adaptation pattern. The network may transmit, in accordance with the DMRS adaptation pattern, a downlink channel that includes one or more resource elements allocated to a TRS that is quasi co-located with the downlink channel. The UE may utilize the DMRS adaptation pattern to decode one or more resource elements associated with the downlink channel that carry the TRS. The UE may perform a channel estimation procedure for the downlink channel using the TRS and may transmit an indication of the channel estimate to the network entity.

### FIELD OF TECHNOLOGY

The following relates to wireless communications, including tracking reference signal (TRS) reuse for channel estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indication of tracking reference signal (TRS) reuse for channel estimation of a downlink channel and an indication of a demodulation reference signal (DMRS) adaptation pattern that is based on the TRS reuse, decoding, based on the TRS reuse for channel estimation, one or more resource elements associated with the downlink channel in accordance with the DMRS adaptation pattern, the one or more resource elements carrying one or more TRSs that are quasi co-located (QCLed) with the downlink channel, and performing, based on the TRS reuse for channel estimation, a channel estimation procedure for the downlink channel using the one or more TRSs.

A UE for wireless communications is described. The UE may include one or more memories storing processor executable code, and one or more processors coupled with the one or more memories. The one or more processors may individually or collectively be operable to execute the code to cause the UE to receive an indication of TRS reuse for channel estimation of a downlink channel and an indication of a DMRS adaptation pattern that is based on the TRS reuse, decode, based on the TRS reuse for channel estimation, one or more resource elements associated with the downlink channel in accordance with the DMRS adaptation pattern, the one or more resource elements carrying one or more TRSs that are QCLed with the downlink channel, and perform, based on the TRS reuse for channel estimation, a channel estimation procedure for the downlink channel using the one or more TRSs.

Another UE for wireless communications is described. The UE may include means for receiving an indication of TRS reuse for channel estimation of a downlink channel and an indication of a DMRS adaptation pattern that is based on the TRS reuse, means for decoding, based on the TRS reuse for channel estimation, one or more resource elements associated with the downlink channel in accordance with the DMRS adaptation pattern, the one or more resource elements carrying one or more TRSs that are QCLed with the downlink channel, and means for performing, based on the TRS reuse for channel estimation, a channel estimation procedure for the downlink channel using the one or more TRSs.

A non-transitory computer-readable medium storing code for wireless communications is described. The code may include instructions executable by one or more processors to receive an indication of TRS reuse for channel estimation of a downlink channel and an indication of a DMRS adaptation pattern that is based on the TRS reuse, decode, based on the TRS reuse for channel estimation, one or more resource elements associated with the downlink channel in accordance with the DMRS adaptation pattern, the one or more resource elements carrying one or more TRSs that are QCLed with the downlink channel, and perform, based on the TRS reuse for channel estimation, a channel estimation procedure for the downlink channel using the one or more TRSs.

Some examples of the method, UEs, and non-transitory computer-readable medium described herein may further include operations, features, means, or instructions for decoding one or more second resource elements associated with the downlink channel in accordance with the DMRS adaptation pattern, the one or more second resource elements carrying one or more DMRSs QCLed with the one or more TRSs, where the channel estimation procedure may be performed using the one or more DMRSs.

In some examples of the method, UEs, and non-transitory computer-readable medium described herein, the one or more second resource elements carrying the one or more DMRSs may be located outside of a coherence area associated with the one or more resource elements carrying the one or more TRSs.

In some examples of the method, UEs, and non-transitory computer-readable medium described herein, the coherence area may be indicated by a first quantity of time units and a second quantity of resource elements and the one or more resource elements carrying the one or more TRSs may be centered within the coherence area.

Some examples of the method, UEs, and non-transitory computer-readable medium described herein may further include operations, features, means, or instructions for receiving, from a network entity, an indication of the coherence area, where the coherence area indicates a segment of time and frequency resources surrounding the one or more resource elements carrying the one or more TRSs.

In some examples of the method, UEs, and non-transitory computer-readable medium described herein, receiving the indication of the DMRS adaptation pattern may include operations, features, means, or instructions for receiving an indication of one or more shift values, where the one or more shift values indicate an offset, from a resource element originally-scheduled to carry the one or more DMRSs, of the one or more second resource elements carrying the one or more DMRSs, and where the one or more shift values include a time shift value, a frequency shift value, or both.

Some examples of the method, UEs, and non-transitory computer-readable medium described herein may further include operations, features, means, or instructions for transmitting, to a network entity, assistance information indicating a request for the DMRS adaptation pattern, where the indication of the DMRS adaptation pattern may be received in response to the assistance information.

In some examples of the method, UEs, and non-transitory computer-readable medium described herein, in accordance with the DMRS adaptation pattern, the downlink channel excludes resource elements carrying a DMRS.

Some examples of the method, UEs, and non-transitory computer-readable medium described herein may further include operations, features, means, or instructions for receiving an indication of a unit of adaptation associated with the DMRS adaptation pattern, where the unit of adaptation includes a resource block, a physical resource group, or a sub-band.

In some examples of the method, UEs, and non-transitory computer-readable medium described herein, the indication of the DMRS adaptation pattern may be received via a radio resource control (RRC) message, a medium access control-control element (MAC-CE), downlink control information (DCI), system information (SI), or a synchronization signal block (SSB).

In some examples of the method, UEs, and non-transitory computer-readable medium described herein, receiving the indication of the DMRS adaptation pattern may include operations, features, means, or instructions for receiving an indication of an index of a lookup table, where the lookup table includes different DMRS adaptation patterns for different numerologies, frequency ranges, UE capabilities, or a combination thereof.

In some examples of the method, UEs, and non-transitory computer-readable medium described herein, the downlink channel includes a rank-1 physical downlink shared channel or a physical downlink control channel.

A method for wireless communications by a network entity is described. The method may include transmitting an indication of TRS reuse for channel estimation and an indication of a DMRS adaptation pattern, transmitting, in accordance with the DMRS adaptation pattern, a downlink channel including one or more resource elements carrying one or more TRSs that are QCLed with the downlink channel, and receiving an indication of a channel estimation of the downlink channel that is based on the one or more resource elements carrying the one or more TRSs.

A network entity for wireless communications is described. The network entity may include one or more memories storing processor executable code, and one or more processors coupled with the one or more memories. The one or more processors may individually or collectively be operable to execute the code to cause the network entity to transmit an indication of TRS reuse for channel estimation and an indication of a DMRS adaptation pattern, transmit, in accordance with the DMRS adaptation pattern, a downlink channel including one or more resource elements carrying one or more TRSs that are QCLed with the downlink channel, and receive an indication of a channel estimation of the downlink channel that is based on the one or more resource elements carrying the one or more TRSs.

Another network entity for wireless communications is described. The network entity may include means for transmitting an indication of TRS reuse for channel estimation and an indication of a DMRS adaptation pattern, means for transmitting, in accordance with the DMRS adaptation pattern, a downlink channel including one or more resource elements carrying one or more TRSs that are QCLed with the downlink channel, and means for receiving an indication of a channel estimation of the downlink channel that is based on the one or more resource elements carrying the one or more TRSs.

A non-transitory computer-readable medium storing code for wireless communications is described. The code may include instructions executable by one or more processors to transmit an indication of TRS reuse for channel estimation and an indication of a DMRS adaptation pattern, transmit, in accordance with the DMRS adaptation pattern, a downlink channel including one or more resource elements carrying one or more TRSs that are QCLed with the downlink channel, and receive an indication of a channel estimation of the downlink channel that is based on the one or more resource elements carrying the one or more TRSs.

Some examples of the method, network entities, and non-transitory computer-readable medium described herein may further include operations, features, means, or instructions for omitting, in accordance with the DMRS adaptation pattern, an originally-scheduled DMRS from the downlink channel and performing rate matching of downlink data into one or more resource elements associated with the originally-scheduled DMRS that do not overlap with the one or more resource elements carrying the one or more TRSs.

In some examples of the method, network entities, and non-transitory computer-readable medium described herein, in accordance with the DMRS adaptation pattern, the downlink channel further includes one or more second resource elements carrying one or more DMRSs.

In some examples of the method, network entities, and non-transitory computer-readable medium described herein, the one or more resource elements carrying the one or more TRSs and the one or more second resource elements carrying the one or more DMRSs may be orthogonal.

In some examples of the method, network entities, and non-transitory computer-readable medium described herein, the one or more resource elements carrying the one or more TRSs and the one or more second resource elements carrying the one or more DMRSs partially overlap in a time domain, a frequency domain, or both.

In some examples of the method, network entities, and non-transitory computer-readable medium described herein, the one or more second resource elements carrying the one or more DMRSs may be located outside of a coherence area associated with the one or more resource elements carrying the one or more TRSs.

In some examples of the method, network entities, and non-transitory computer-readable medium described herein, the coherence area may be indicated by a first quantity of time units and a second quantity of resource elements and the one or more resource elements carrying the one or more TRSs may be centered within the coherence area.

Some examples of the method, network entities, and non-transitory computer-readable medium described herein may further include operations, features, means, or instructions for transmitting, to at least one UE, an indication of the coherence area, where the coherence area indicates a segment of time and frequency resources surrounding the one or more resource elements carrying the one or more TRSs over which a characteristic of the downlink channel may be constant.

In some examples of the method, network entities, and non-transitory computer-readable medium described herein, transmitting the indication of the DMRS adaptation pattern may include operations, features, means, or instructions for transmitting an indication of one or more shift values, where the one or more shift values indicate an offset, from a resource element originally-scheduled to carry the one or more DMRSs, of the one or more second resource elements carrying the one or more DMRSs, and where the one or more shift values include a time shift value, a frequency shift value, or both.

In some examples of the method, network entities, and non-transitory computer-readable medium described herein, transmitting the indication of the DMRS adaptation pattern may include operations, features, means, or instructions for transmitting the indication of the DMRS adaptation pattern based on a channel quality associated with the downlink channel satisfying a threshold value.

Some examples of the method, network entities, and non-transitory computer-readable medium described herein may further include operations, features, means, or instructions for receiving, from a UE, assistance information indicating a request for the DMRS adaptation pattern, where the indication of the DMRS adaptation pattern may be transmitted based on reception of the assistance information.

Some examples of the method, network entities, and non-transitory computer-readable medium described herein may further include operations, features, means, or instructions for transmitting an indication of a unit of adaptation associated with the DMRS adaptation pattern, where the unit of adaptation includes a resource block, a physical resource group, or a sub-band.

In some examples of the method, network entities, and non-transitory computer-readable medium described herein, the indication of the DMRS adaptation pattern may be transmitted via an RRC message, a MAC-CE, DCI, SI, or an SSB.

In some examples of the method, network entities, and non-transitory computer-readable medium described herein, transmitting the indication of the DMRS adaptation pattern may include operations, features, means, or instructions for transmitting an indication of an index of a lookup table, where the lookup table includes different DMRS adaptation patterns for different numerologies, frequency ranges, UE capabilities, or a combination thereof.

In some examples of the method, network entities, and non-transitory computer-readable medium described herein, the downlink channel includes a rank-1 physical downlink shared channel or a physical downlink control channel.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports tracking reference signal (TRS) reuse for channel estimation in accordance with one or more aspects of the present disclosure.

FIG. 2 shows an example of a portion of a wireless communications system that supports TRS reuse for channel estimation in accordance with one or more aspects of the present disclosure.

FIG. 3 to 7 show examples of reference signal configurations that support TRS reuse for channel estimation in accordance with one or more aspects of the present disclosure.

FIG. 8 shows an example of a signal flow that supports TRS reuse for channel estimation in accordance with one or more aspects of the present disclosure.

FIGS. 9 and 10 show block diagrams of devices that support TRS reuse for channel estimation in accordance with one or more aspects of the present disclosure.

FIG. 11 shows a block diagram of a communications manager that supports TRS reuse for channel estimation in accordance with one or more aspects of the present disclosure.

FIG. 12 shows a diagram of a system including a device that supports TRS reuse for channel estimation in accordance with one or more aspects of the present disclosure.

FIGS. 13 and 14 show block diagrams of devices that support TRS reuse for channel estimation in accordance with one or more aspects of the present disclosure.

FIG. 15 shows a block diagram of a communications manager that supports TRS reuse for channel estimation in accordance with one or more aspects of the present disclosure.

FIG. 16 shows a diagram of a system including a device that supports TRS reuse for channel estimation in accordance with one or more aspects of the present disclosure.

FIGS. 17 and 18 show flowcharts illustrating methods that support TRS reuse for channel estimation in accordance with one or more aspects of the present disclosure.

### DETAILED DESCRIPTION

Various aspects of the present disclosure relate to techniques for the reuse of tracking reference signals (TRSs) for channel estimation. In some wireless communications systems, different types of reference signals may be used for different purposes. TRSs and demodulation reference signals (DMRSs) are two types of reference signals that may be utilized.

TRSs may be primarily utilized by a receiving device, such as a user equipment (UE), for synchronization, tracking of a time/frequency offset, estimation of a power delay profile, estimation of Doppler, etc. In some cases, TRSs may be scheduled separately from a physical downlink shared channel (PDSCH) and may be transmitted from a single antenna port. DMRSs may be primarily utilized for channel estimation by a receiving device, such as a UE or a network entity, to assist in demodulation of received data. As a result, DMRSs may not be standalone signals and are, instead, may be scheduled together with another signal, such as a PDSCH or physical uplink shared channel (PUSCH). The DMRSs may be transmitted from either a single antenna port or multiple antenna ports. In some cases, a reliability of DMRS-based channel estimation may depend on an outcome of TRS processing. For instance, the DRMS-based channel estimation may leverage various parameters determined based on TRS processing (e.g., a time/frequency offset, power delay profile, Doppler estimation, etc.) to perform channel estimation of a downlink channel.

In some wireless communications systems, a TRS and a DMRS may be quasi-located (QCLed), such as transmitted by a network entity from a same antenna port. If the TRS and PDSCH overlap in frequency, the network entity may indicate the TRS resources as zero power-CSI-RS (ZP-CSI-RS) for PDSCH to rate match around in order to ensure that the PDSCH is not scheduled on the TRS resources. In this way, the TRS resources and the PDSCH resources, including the DMRS, may be orthogonal (e.g., may not overlap) and intra-UE interference may be mitigated. However, this may cause the TRS and the DMRS to occupy more resources than are necessary for channel estimation. These conditions may lead to reduced spectral efficiency and present challenges in environments in which there is a spectrum shortage, such as where the available frequency bands allocated for communication are insufficient to support data communication needs.

In accordance with various techniques described herein, improved techniques may enable TRS-based channel estimation. For instance, TRS resources may be reused for channel estimation while reducing DMRS resource usage and, thereby, conversing such resources for data, such as PDSCH.

Aspects of the disclosure are initially described in the context of wireless communications systems. Aspects of the disclosure are further illustrated by and described with reference to apparatus diagrams, system diagrams, and flowcharts that relate to TRS reuse for channel estimation.

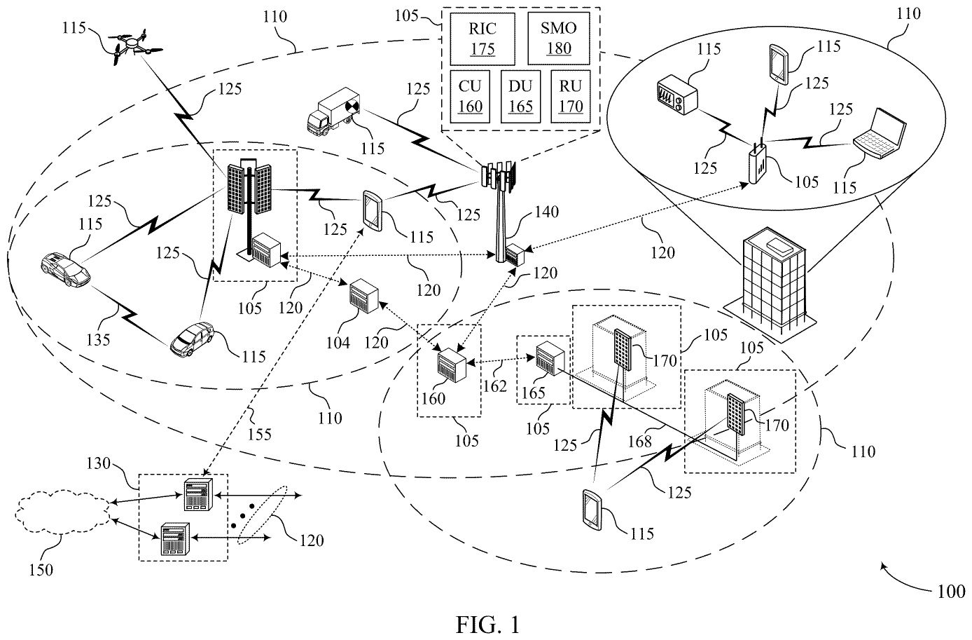

FIG. 1 shows an example of a wireless communications system 100 that supports TRS reuse for channel estimation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support TRS reuse for channel estimation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some implementations, a network entity 105 may transmit, to a UE 115, an indication that the UE is perform TRS-based channel estimation, such as by reusing TRS resources for the channel estimation. In such cases, the network entity 105 may further transmit to the UE 115 a DMRS adaptation pattern. The DMRS adaptation pattern may be a reference signal configuration pattern that indicates a configuration of resource elements associated with a DMRS, a TRS, or both. The network entity 105 may, thereafter, receive a downlink channel (e.g., a Rank-1 PDSCH or a physical downlink control channel (PDCCH)) in accordance with the DMRS adaptation pattern. For instance, the downlink channel may include, in accordance with the DMRS adaptation pattern, resource elements associated with a TRS that is QCLed with the downlink channel and, optionally, resource elements associated with a DMRS. The UE 115 may receive and decode the downlink channel in accordance with the DMRS adaptation pattern. As such, the UE 115 may decode one or more of the resource elements carrying the TRS and may the TRS resources in performing a channel estimation procedure for the downlink channel.

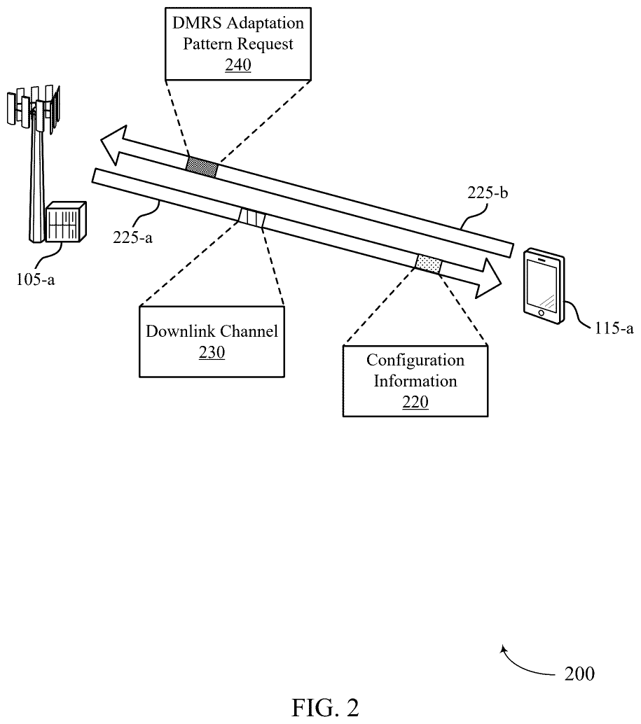

FIG. 2 shows an example of a portion of a wireless communications system 200 that supports TRS reuse for channel estimation in accordance with one or more aspects of the present disclosure. In some cases, the wireless communications system 200 may support or be supported by aspects of the wireless communications system 100 described with reference to FIG. 1. For instance, the wireless communications system 200 may include a network entity 105-a and a UE 115-a, which may be examples of network entities 105 and UEs 115, respectively, described with reference to FIG. 1. The network entity 105-a and UE 115-a may communicate using communication links 225 (e.g., a Uu link), which may be examples of the communication link(s) 125 described with reference to FIG. 1. For instance, the network entity 105-a may transmit downlink communications, such as a configuration information 220 or a downlink channel 230 (e.g., Rank-1 PDSCH or a PDCCH) QCLed with one or more TRSs, to the UE 115-a, via a downlink communication link 225-a, and the UE 115-a may transmit uplink communications, such as an uplink message 240 including an indication of a downlink channel estimate, to the network entity 105-a, via an uplink communication link 225-b.

In accordance with aspects described herein, the wireless communications system 200 may support the reuse of TRS resources for channel estimation. For instance, the network entity 105-a may transmit, to the UE 115-a, configuration information 220 that includes an indication that the UE 115-a is to reuse TRS resources for channel estimation, an indication of a DMRS adaptation pattern, and an indication of one or more DMRS adaptation parameters.

The indication that the UE 115-a is to reuse TRS resources for channel estimation may be an indication that the UE 115-a is to perform TRS-based channel estimation of the downlink channel using one or more TRS resources indicated in a DMRS adaptation pattern.

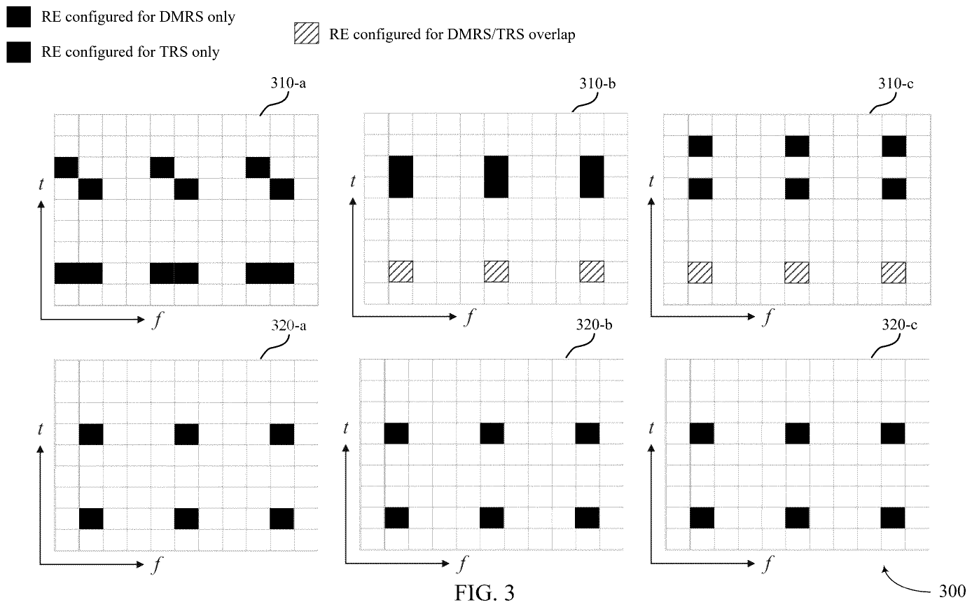

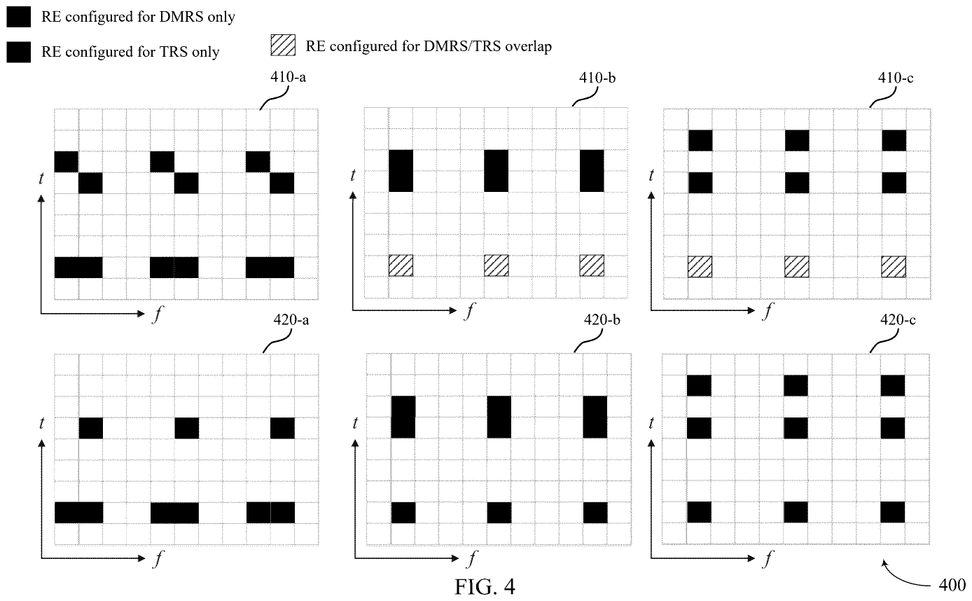

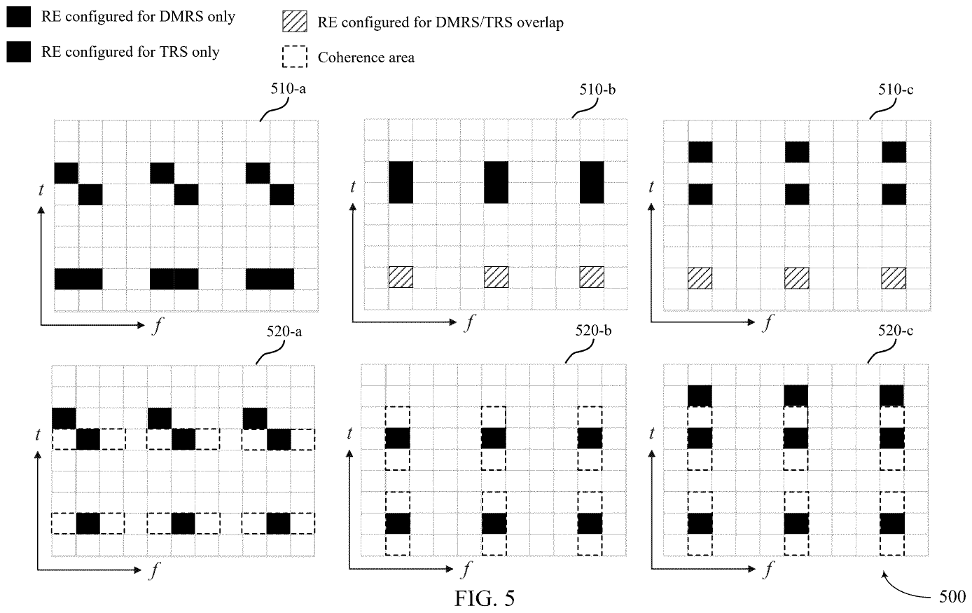

The DMRS adaptation pattern may be a time/frequency configuration pattern associated with a configuration of TRS resources, DMRS resources, or both. The configuration pattern may reflect a density or distribution of allocated resources for a single resource unit. The network entity 105-a may consider various options for configuring the TRS and DMRS resources. In some examples, the network entity 105-a may decide to waive the scheduling of a DMRS and schedule a TRS to be transmitted (e.g., without scheduling a DMRS), such as described in further detail with respect to FIG. 3. In other examples, the network entity 105-b may selectively schedule a DMRS to be combined with a TRS (e.g., either to be partially overlapping with the TRS or not overlapping with the TRS), such as described in further detail with respect to FIG. 4. In other examples, the network entity 105-b may schedule a TRS and waive the scheduling of a DMRS within a proximity, such as within a coherence area, of the TRS, such as described in further detail with respect to FIG. 5.

The DMRS adaptation parameters may include a unit of adaptation associated with the DMRS adaptation pattern. The unit of adaptation may indicate whether the DMRS adaptation pattern is indicated at a resource block, a physical resource group, a sub-band (e.g., where the sub band may be defined as the bandwidth intersection over a TRS and a DMRS), or other level. The DMRS parameters may additionally, or alternatively, include an indication of one or more shift values, where each shift value indicates an offset of a DMRS-allocated resource element in the DMRS adaptation pattern from a resource element originally-scheduled to carry the DMRS. The shift value may be a time shift value or a frequency shift value. The DMRS parameters may additionally, or alternatively, include an indication of a coherence area. The coherence area may refer to a segment of time and frequency resources surrounding one or more TRS-allocated resource elements in a DMRS adaptation pattern. For instance, the one or more TRS-allocated resource elements may be centered within the coherence area. The coherence area may be indicated by a first quantity of time units (e.g., m slots) and a second quantity of resource elements (e.g., n resource elements).

In some cases, the configuration information (e.g., the indication to reuse TRS resources for channel estimation, the DMRS adaptation pattern, or the DMRS adaptation parameters) may be transmitted from the network entity 105-a, to the UE 115-a, via RRC, a MAC-control element (MAC-CE), downlink control information (DCI), system information (SI), or a synchronization signal block (SSB). The manner in which the configuration information is transmitted to the UE 115-a may be based on the manner in which a downlink channel (e.g., a Rank-1 PDSCH or PDCCH) and a QCLed TRS are to be transmitted to the UE 115-a by the network entity 105-a. For instance, in cases where the downlink channel is unicast to the UE 115-a, the configuration information may be transmitted via RRC, MAC-CE, or DCI scrambled with a UE identifier (e.g., a cell radio network temporary identifier (C-RNTI)). In cases where the downlink channel is groupcast, multicast, or broadcast to a UE group including the UE 115-a, the configuration information may be transmitted via RRC, MAC-CE, SI, or DCI scrambled with a group identifier (e.g., a group RNTI). In some cases, a periodic TRS may be QCLed with the downlink channel and may be transmitted by the network entity 105-a to replace DMRS of SI (e.g., remaining minimum system information (RMSI) or other system information (OSI)). In such cases, the DMRS adaptation pattern, the DMRS adaptation parameters, or both may be specified in one or more tables, such as one or more lookup tables, and an index identifying an entry in the lookup table may be explicitly or implicitly indicated in SSB (e.g., via a scrambling sequence, master information block (MIB)/physical broadcast channel (PBCH) payload, or cyclic redundancy check (CRC)). In some instances, the one or more lookup tables may specify different DMRS adaptation patterns or different DMRS adaptation parameters for different numerologies, frequency ranges, or UE capabilities.

In some cases, the network entity 105-a may transmit the configuration information (e.g., the indication to reuse TRS resources for channel estimation, the DMRS adaptation pattern, or the DMRS adaptation parameters) to the UE 115-a in response to receiving assistance information from the UE 115-a requesting the configuration information. In other cases, the network entity 105-a may initiate transmission of the configuration information on its own, such as when a downlink channel and a TRS are QCLed, or in some cases, when the downlink channel and the TRS are QCLed and a channel quality associated with the downlink channel is below a channel quality threshold.

After transmitting the configuration information 220, the network entity 105-a may transmit, to the UE 115-a, a downlink channel 230, in accordance with the DMRS adaptation pattern indicated in the configuration information 220. The downlink channel 230 may include one or more resource elements carrying one or more TRSs that are quasi QCLed with the downlink channel 230. In some cases, the downlink channel 230 may additionally include one or more resource elements carrying one or more DMRSs. The UE 115-a may receive the downlink channel 230 and decode the one or more resource elements carrying the one or more TRSs. The UE 115-a may use the one or more TRSs to perform a channel estimation of the downlink channel 230. In some cases, the UE 115-a may transmit, to the network entity 105-a, an uplink message 240 that includes an indication of the estimation of the downlink channel 230. Reusing the TRS resources for channel estimation may improve spectral efficiency in the wireless communications system 200.

FIG. 3 shows an example of reference signal configurations 300 that support TRS reuse for channel estimation in accordance with one or more aspects of the present disclosure. In some cases, the reference signal configurations 300 may support or be supported by aspects of the wireless communications systems 100 and 200, described with reference to FIGS. 1 and 2. For instance, the reference signal configurations 300 may be various reference signal configurations including one or more resources allocated for one or more TRSs, one or more resources allocated for one or more DMRSs, or a combination thereof. The reference signal configurations 300 may include original reference signal configurations 310 (e.g., 310-a, 310-b, and 310-c) that are based on an original configuration of TRS and DMRS resources, and new reference signal configurations 320 (e.g., 320-a, 320-b, and 320-c) that enable a UE, such as UE 115-a of FIG. 2, to perform TRS-based channel estimation.

The original reference signal configurations 310 may reflect a configuration pattern (e.g., a legacy configuration pattern) in a case where the UE is not expected to reuse TRS resources for channel estimation. The new reference signal configurations 320 may reflect a configuration pattern in the case where the UE is expected to reuse TRS resources for channel estimation. In some cases, the new reference signal configurations 320 may be referred to as DMRS adaptation patterns. For instance, one or more of the new reference signal configurations 320 may be indicated in configuration information (such as configuration information 220 of FIG. 2) and may be transmitted to the UE 115-a when a downlink channel (e.g., Rank-1 PDSCH or PDCCH) and a TRS are QCLed.

In some implementations, when the downlink channel and the TRS are QCLed and TRS-based channel estimation is to be performed by the UE 115-a, the network entity 105-a may determine, based on an original configuration of DMRS and TRS resources (e.g., based on the original reference signal configurations 310), to generate new reference signal configurations 320 in which TRSs are scheduled and DMRSs are waived. The network entity 105-a may decide to waive the scheduling of DMRSs in the new reference signal configuration 320 (e.g., in the DMRS adaptation pattern) irrespective of whether the DMRS and TRS resources overlap (e.g., may or may not have a collision) in an original configuration. In such cases, the network entity 105-a may instead use the remaining resource elements to transmit data (e.g., PDSCH or PDCCH). That is, data may be rate matched into the resource elements that were originally allocated for the DMRS and that do not overlap with the TRS resource elements.

For instance, referring to original reference signal configuration 310-a, although no resource elements are configured for an overlap of DMRS and TRS, the network entity 105-a may determine new reference signal configuration 320-a, in which TRSs are scheduled for transmission and the DMRSs are waived (e.g., dropped). Likewise, referring to original reference signal configurations 310-a and 310-b, in which there are some overlapping DMRS and TRS resource elements, the network entity 105-a may determine new reference signal configurations 320-a and 320-b, respectively, in which TRSs are scheduled for transmission and the DMRSs are waived (both those that were overlapping and those that were not). This scheduling approach may allow the network entity 105-a to reduce signaling overhead by not transmitting the DMRS, thus, yielding a 50% savings in overhead in this example.

FIG. 4 shows an example of reference signal configurations 400 that support TRS reuse for channel estimation in accordance with one or more aspects of the present disclosure. In some cases, the reference signal configurations 400 may support or be supported by aspects of the wireless communications systems 100 and 200, described with reference to FIGS. 1 and 2. For instance, the reference signal configurations 400 may be various reference signal configurations including one or more resources allocated for one or more TRSs, one or more resources allocated for one or more DMRSs, or a combination thereof. The reference signal configurations 400 may include original reference signal configurations 410 (e.g., 410-a, 410-b, and 410-c) that are based on an original configuration of TRS and DMRS resources, and new reference signal configurations 420 (e.g., 420-a, 420-b, and 420-c) that enable a UE, such as UE 115-a of FIG. 2, to perform TRS-based channel estimation.

The original reference signal configurations 410 may reflect a configuration pattern (e.g., a legacy configuration pattern) in a case where the UE is not expected to reuse TRS resources for channel estimation. The new reference signal configurations 420 may reflect a configuration pattern in the case where the UE is expected to reuse TRS resources for channel estimation. In some cases, the new reference signal configurations 420 may be referred to as DMRS adaptation patterns. For instance, one or more of the new reference signal configurations 420 may be indicated in configuration information (such as configuration information 220 of FIG. 2) and may be transmitted to the UE 115-a when a downlink channel (e.g., Rank-1 PDSCH or PDCCH) and a TRS are QCLed.

In some implementations, when the downlink channel and the TRS are QCLed and TRS-based channel estimation is to be performed by the UE 115-a, the network entity 105-a may determine, based on an original configuration of DMRS and TRS resources (e.g., based on the original reference signal configurations 410), to generate new reference signal configurations 420 in which one or more DMRSs are selectively scheduled to be combined with one or more TRSs. For instance, in some cases, such as in the case of high Doppler, the network entity 105-a may schedule DMRS more often than TRS. Because the TRS may be able to transmit in, for example, at most two symbols in a slot, and if the DMRS is to be transmitted in 3 symbols, the network entity 105-a may reserve 1 symbol for DMRS. In this case, the network entity 105-a may schedule both the DMRS and the TRS. For instance, on the symbols on which the TRS is scheduled, the network entity 105-a may waive the DMRS, and on the symbols on which the TRS is not scheduled, the network may schedule the DMRS. Accordingly, the network entity 105-a may determine to selectively schedule DMRS in a new reference signal configuration 420 (e.g., in a DMRS adaptation pattern) irrespective of whether DMRS and TRS resource elements overlap in an original reference signal configuration 410.

For instance, referring to original reference signal configuration 410-a, although no resource elements are configured for an overlap of DMRS and TRS, the network entity 105-a may determine new reference signal configuration 420-a, in which DMRSs are selectively scheduled for transmission. Likewise, referring to original reference signal configurations 410-a and 410-b, in which there are some overlapping DMRS and TRS resource elements, the network entity 105-a may determine new reference signal configurations 420-a and 420-b, respectively, in which DMRSs scheduled on a resource element with a TRS are waived (e.g., the overlapping DMRSs) and DMRS scheduled on a resource element on which the TRS is not scheduled are not waived. This scheduling approach may allow the network entity 105-a to reduce signaling overhead by selectively transmitting DMRS, thus, yielding a 25% savings in overhead in this example.

FIG. 5 shows an example of reference signal configurations 500 that support TRS reuse for channel estimation in accordance with one or more aspects of the present disclosure. In some cases, the reference signal configurations 500 may support or be supported by aspects of the wireless communications systems 100 and 200, described with reference to FIGS. 1 and 2. For instance, the reference signal configurations 500 may be various reference signal configurations including one or more resources allocated for one or more TRSs, one or more resources allocated for one or more DMRSs, or a combination thereof. The reference signal configurations 500 may include original reference signal configurations 510 (e.g., 510-a, 510-b, and 510-c) that are based on an original configuration of TRS and DMRS resources, and new reference signal configurations 520 (e.g., 520-a, 520-b, and 520-c) that enable a UE, such as UE 115-a of FIG. 2, to perform TRS-based channel estimation.

The original reference signal configurations 510 may reflect a configuration pattern (e.g., a legacy configuration pattern) in a case where the UE is not expected to reuse TRS resources for channel estimation. The new reference signal configurations 520 may reflect a configuration pattern in the case where the UE is expected to reuse TRS resources for channel estimation. In some cases, the new reference signal configurations 520 may be referred to as DMRS adaptation patterns. For instance, one or more of the new reference signal configurations 520 may be indicated in configuration information (such as configuration information 220 of FIG. 2) and may be transmitted to the UE 115-a when a downlink channel (e.g., Rank-1 PDSCH or PDCCH) and a TRS are QCLed.

In some implementations, when the downlink channel and the TRS are QCLed and TRS-based channel estimation is to be performed by the UE 115-a, the network entity 105-a may determine, based on an original configuration of DMRS and TRS resources (e.g., based on the original reference signal configurations 510), to generate new reference signal configurations 520 in which one or more DMRSs in a proximity of one or more TRSs may be waived. For instance, a coherence area may be a defined area around a given TRS-allocated resource element for which a channel estimate associated with the TRS-allocated resource element may be reused. For instance, a TRS-allocated resource element may be centered within the coherence area, and a channel estimate for the TRS resource may be applicable to the resource elements associated with the coherence area. The size of the coherence area may be indicated by m time units and n resource elements. In some instances, the size of the coherence area may be channel dependent or UE dependent.

For instance, referring to original reference signal configuration 510-a, a coherence area of size m=1 and n=3 may be defined around a TRS-allocated resource element, and the network entity 105-a may determine new reference signal configuration 520-a, in which DMRSs scheduled within the coherence area are waived. Likewise, referring to original reference signal configurations 510-a and 510-b, a coherence area of size m=3 and n=1 may be defined around a TRS-allocated resource element, and the network entity 105-a may determine new reference signal configurations 520-a and 520-b, respectively, in which DMRSs scheduled within the coherence area are waived. Although this approach, like the approach described with respect to FIG. 4, may yield a 25% savings in signaling overhead, this approach may allow for a denser sampling of DMRS and TRSs in a time domain relative to the approach shown with respect to FIG. 4, which may lead to improved resolution for interpolation.

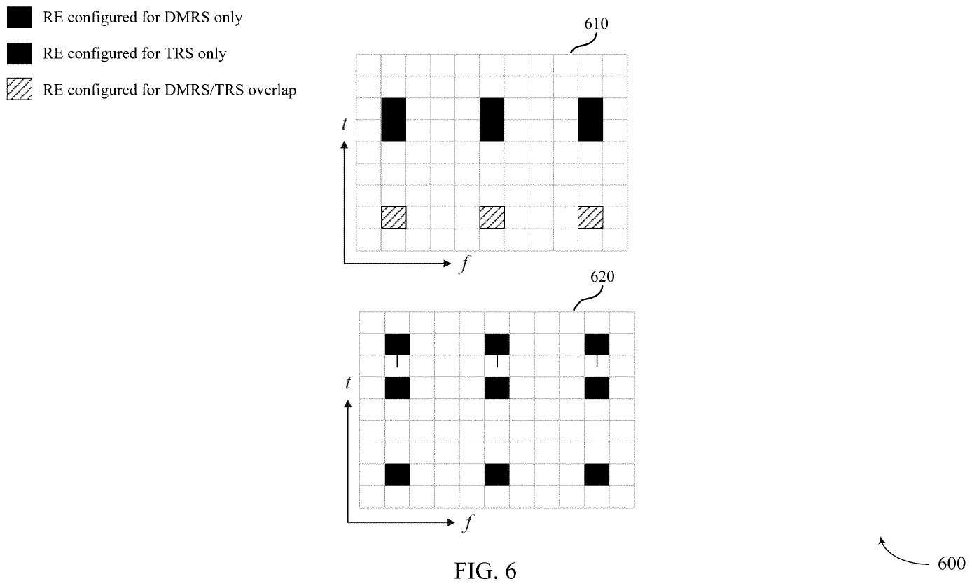

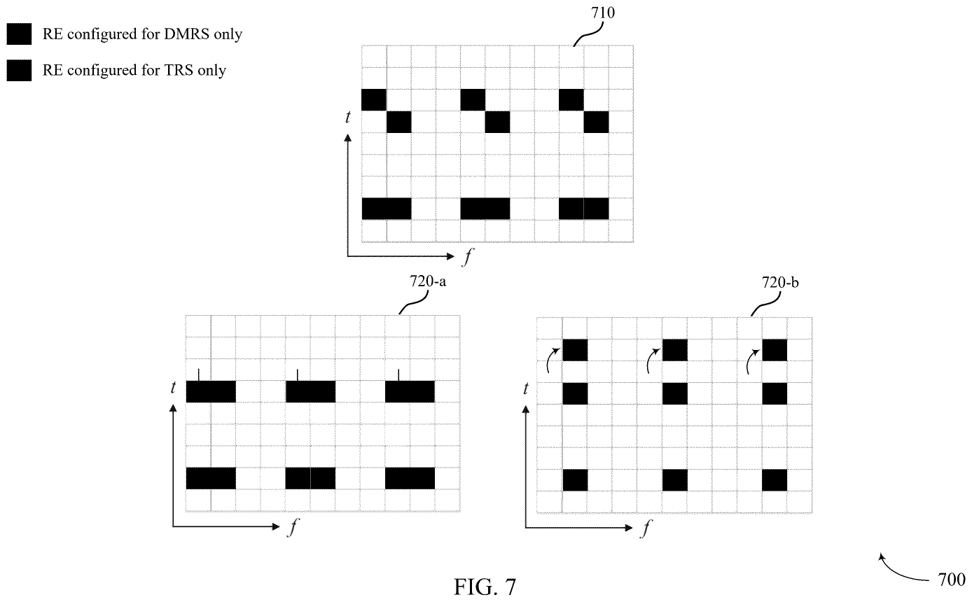

FIGS. 6 and 7 show examples of reference signal configurations 600 and 700 that support TRS reuse for channel estimation in accordance with one or more aspects of the present disclosure. In some cases, the reference signal configurations 600 and 700 may support or be supported by aspects of the wireless communications systems 100 and 200, described with reference to FIGS. 1 and 2, and reference signal configurations 300, 400, and 500, described with reference to FIGS. 3, 4, and 5. For instance, the reference signal configurations 600 and 700 may be various reference signal configurations including one or more resources allocated for one or more TRSs, one or more resources allocated for one or more DMRSs, or a combination thereof. The reference signal configurations 600 and 700 may include original reference signal configuration 610 and original reference signal configuration 710, respectively, that are based on an original configuration of TRS and DMRS resources, and new reference signal configuration 620 and new reference signal configuration 720 (e.g., 720-a and 720-b), respectively, that enable a UE, such as UE 115-a of FIG. 2, to perform TRS-based channel estimation.

The original reference signal configurations 610 and 710 may reflect configuration patterns (e.g., a legacy configuration patterns) in a case where the UE is not expected to reuse TRS resources for channel estimation. The new reference signal configurations 620 and 720 may reflect configuration patterns in the case where the UE is expected to reuse TRS resources for channel estimation. In some cases, the new reference signal configurations 620 and 720 may be referred to as DMRS adaptation patterns. For instance, one or more of the new reference signal configurations 620 or 720 may be indicated in configuration information (such as configuration information 220 of FIG. 2) and may be transmitted to the UE 115-a when a downlink channel (e.g., Rank-1 PDSCH or PDCCH) and a TRS are QCLed.

In some implementations, to avoid irregular DMRS patterns that may result from TRS reuse and to improve a reliability of channel estimation, instead of determining to waive the scheduling and transmission of DMRS under certain circumstances (such as described with respect to FIGS. 3, 4, and 5), the network entity 105-a may indicate the new reference signal configuration 620 or 720 (e.g., the DMRS adaptation pattern) in a time domain, a frequency domain, or both. For instance, the network entity 105-a may indicate a relative shift (e.g., an offset), in a time domain, a frequency domain, or both, of one or more DMRS-allocated resource elements from an original location in the original reference signal configuration 610 or 710. In such cases, the time offsets or frequency offsets may serve as an indication of the new reference signal configuration 620 or 720 (e.g., an indication of the DMRS adaptation pattern).

For instance, referring to original reference signal configuration 610 of FIG. 6, in one example, rather than waiving the originally-scheduled DMRS, the network entity 105-a may instead configure the new reference signal configuration 620 such that one or more of the DMRS resource elements are shifted in the time domain by x time offset value (e.g., by one symbol), so as to align one or more of the DMRS resource elements with one or more of the TRS resource elements.

Referring to original reference signal configuration 710 of FIG. 7, in another example, rather than waiving the originally-scheduled DMRS, the network entity 105-a may instead configure the new reference signal configuration 720-a such that one or more of the DMRS resource elements are shifted in the time domain by x time offset value (e.g., to align with one or more of the TRS resource elements). Alternatively, the network entity 105-a may configure the new reference signal configuration 720-b such that one or more of the DMRS resource elements are shifted in both a time and a frequency domain, such as shifted in the time domain by x time offset value and shifted in the frequency domain by y frequency offset value (e.g., to align with one or more of the TRS resource elements).

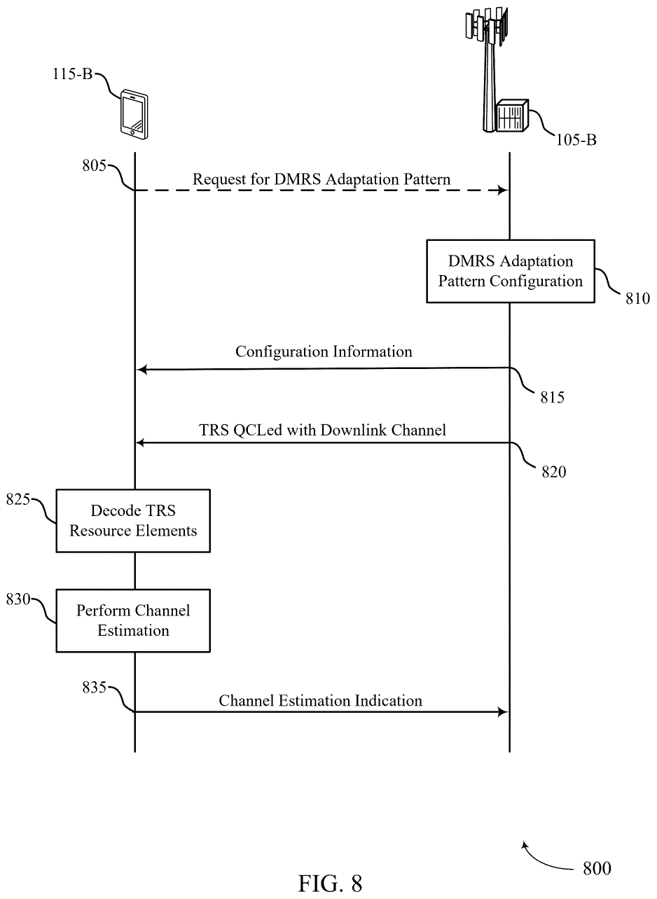

FIG. 8 shows an example of a signal flow 800 that supports TRS reuse for channel estimation in accordance with one or more aspects of the present disclosure. In some examples, signal flow 800 may implement aspects of or may be implemented by aspects of wireless communications systems 100 and 200, described with reference to FIGS. 1 and 2, and reference signal configurations 300, 400, 500, and 600, described with reference to FIGS. 3, 4, 5, and 6. Signal flow 800 may be implemented by a UE 115-b and a network entity 105-b as described herein. In the following description of the signal flow 800, the communications between the UE 115-b and the network entity 105-b may be transmitted in a different order than the example order shown, or the operations performed by the UE 115-b and network entity 105-b may be performed in different orders or at different times. Some operations may also be omitted from the signal flow 800, and other operations may be added to the signal flow 800. In some examples, the operations illustrated in signal flow 800 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 805, in some cases, the UE 115-b may transmit, and the network entity 105-b may receive a request for a DMRS adaptation pattern. For instance, the UE 115-b may initiate the request based on channel conditions associated with a downlink channel satisfying a quality threshold.

At 810, the network entity 105-b may configure a DMRS adaptation pattern. For instance, in some cases, the network entity 105-b may configure the DMRS adaptation pattern to waive the scheduling and transmission of a DMRS, and may instead (e.g., only) schedule resources for a TRS. In some cases, the network entity 105-b may configure the DMRS adaptation pattern to selectively schedule and transmit a DMRS to be combined with a TRS (e.g., either partially overlapping with the TRS or not overlapping with the TRS). In some cases, the network entity 105-b may configure the DMRS adaptation pattern to schedule and transmit a TRS and to waive the scheduling of a DMRS within a proximity of a TRS (e.g., within a coherence area surrounding a TRS). In some cases, the network entity 105-b may configure the DMRS adaptation pattern to indicate a time or frequency shift or offset of a resource element associated with a DMRS relative to an originally-scheduled location of the DMRS resource element.

At 815, the network entity 105-b may transmit, and the UE 115-b may receive, configuration information. The configuration information may include an indication for the UE 115-b to reuse one or more TRS resources for channel estimation of the downlink channel, an indication of a DMRS adaptation pattern, and indication of one or more DMRS adaptation parameters (e.g., an indication of a unit of adaptation associated with the DMRS adaptation pattern, an indication of one or more time or frequency shift or offset values, or an indication of a coherence area), or a combination thereof. The configuration information may be transmitted from the network entity 105-b, to the UE 115-a, via RRC, a MAC-CE, DCI, SI, or an SSB.

At 820, the network entity 105-b may transmit, and the UE 115-b may receive, a TRS that is QCLed with a downlink channel (e.g., a Rank-1 PDSCH or a PDCCH). For instance, in accordance with the DMRS adaptation pattern, the network entity 105-b may transmit, and the UE 115-b may receive, a downlink channel including one or more resource elements carrying one or more TRSs that are QCLed with the downlink channel. In some cases, the downlink channel may additionally include one or more resource elements carrying one or more DMRSs.

At 825, the UE 115-b may decode one or more resource elements of the downlink channel that carry the TRS. For instance, the UE 115-b may utilize the DMRS adaptation pattern to locate, in the downlink channel, the one or more resource elements carrying the TRS. The UE 115-b may decode the one or more resources carrying the TRS. In some cases, the UE 115-a may additionally utilize the DMRS adaptation pattern to locate and decode one or more resource elements carrying the DMRS.

At 830, the UE 115-b may utilize the TRS for performing a channel estimation of the downlink channel. In some cases, the UE 115-b may additionally utilize the DMRS for performing the channel estimation of the downlink channel.

At 835, the UE 115-b may transmit, and the network entity 105-b may receive, an indication of the channel estimation of the downlink channel.

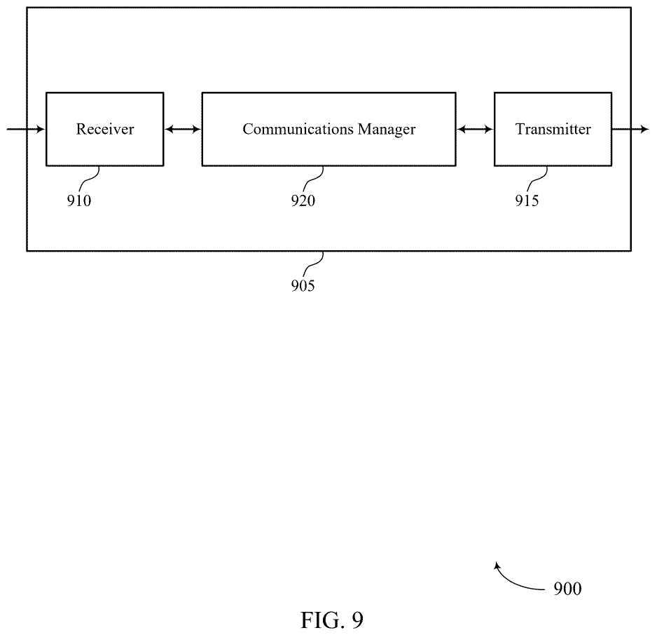

FIG. 9 shows a block diagram 900 of a device 905 that supports TRS reuse for channel estimation in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to TRS reuse for channel estimation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to TRS reuse for channel estimation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of TRS reuse for channel estimation as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving an indication of TRS reuse for channel estimation of a downlink channel and an indication of a DMRS adaptation pattern that is based on the TRS reuse. The communications manager 920 is capable of, configured to, or operable to support a means for decoding, based on the TRS reuse for channel estimation, one or more resource elements associated with the downlink channel in accordance with the DMRS adaptation pattern, the one or more resource elements carrying one or more TRSs that are QCLed with the downlink channel. The communications manager 920 is capable of, configured to, or operable to support a means for performing, based on the TRS reuse for channel estimation, a channel estimation procedure for the downlink channel using the one or more TRSs.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

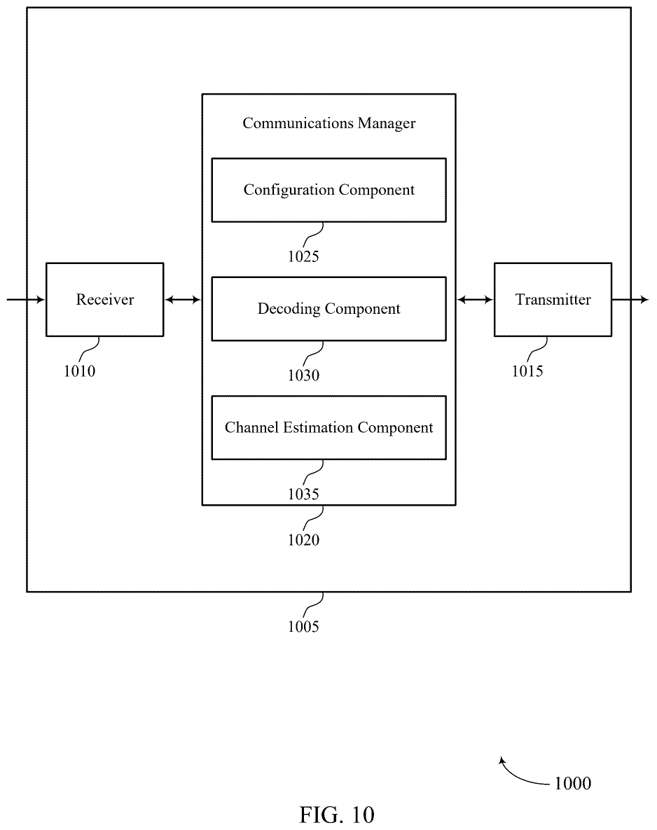

FIG. 10 shows a block diagram 1000 of a device 1005 that supports TRS reuse for channel estimation in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to TRS reuse for channel estimation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to TRS reuse for channel estimation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of TRS reuse for channel estimation as described herein. For example, the communications manager 1020 may include a configuration component 1025, a decoding component 1030, a channel estimation component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration component 1025 is capable of, configured to, or operable to support a means for receiving an indication of TRS reuse for channel estimation of a downlink channel and an indication of a DMRS adaptation pattern that is based on the TRS reuse. The decoding component 1030 is capable of, configured to, or operable to support a means for decoding, based on the TRS reuse for channel estimation, one or more resource elements associated with the downlink channel in accordance with the DMRS adaptation pattern, the one or more resource elements carrying one or more TRSs that are QCLed with the downlink channel. The channel estimation component 1035 is capable of, configured to, or operable to support a means for performing, based on the TRS reuse for channel estimation, a channel estimation procedure for the downlink channel using the one or more TRSs.

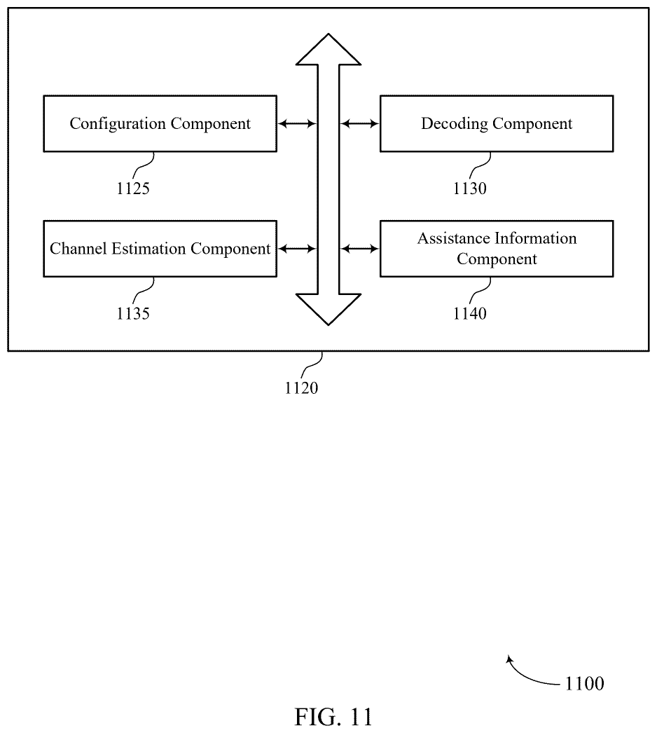

FIG. 11 shows a block diagram 1100 of a communications manager 1120 that supports TRS reuse for channel estimation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of TRS reuse for channel estimation as described herein. For example, the communications manager 1120 may include a configuration component 1125, a decoding component 1130, a channel estimation component 1135, an assistance information component 1140, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The configuration component 1125 is capable of, configured to, or operable to support a means for receiving an indication of TRS reuse for channel estimation of a downlink channel and an indication of a DMRS adaptation pattern that is based on the TRS reuse. The decoding component 1130 is capable of, configured to, or operable to support a means for decoding, based on the TRS reuse for channel estimation, one or more resource elements associated with the downlink channel in accordance with the DMRS adaptation pattern, the one or more resource elements carrying one or more TRSs that are QCLed with the downlink channel. The channel estimation component 1135 is capable of, configured to, or operable to support a means for performing, based on the TRS reuse for channel estimation, a channel estimation procedure for the downlink channel using the one or more TRSs.

In some examples, the decoding component 1130 is capable of, configured to, or operable to support a means for decoding one or more second resource elements associated with the downlink channel in accordance with the DMRS adaptation pattern, the one or more second resource elements carrying one or more DMRSs QCLed with the one or more TRSs, where the channel estimation procedure is performed using the one or more DMRSs.

In some examples, the one or more second resource elements carrying the one or more DMRSs are located outside of a coherence area associated with the one or more resource elements carrying the one or more TRSs.

In some examples, the coherence area is indicated by a first quantity of time units and a second quantity of resource elements. In some examples, the one or more resource elements carrying the one or more TRSs are centered within the coherence area.

In some examples, the configuration component 1125 is capable of, configured to, or operable to support a means for receiving, from a network entity, an indication of the coherence area, where the coherence area indicates a segment of time and frequency resources surrounding the one or more resource elements carrying the one or more TRSs.

In some examples, to support receiving the indication of the DMRS adaptation pattern, the configuration component 1125 is capable of, configured to, or operable to support a means for receiving an indication of one or more shift values, where the one or more shift values indicate an offset, from a resource element originally-scheduled to carry the one or more DMRSs, of the one or more second resource elements carrying the one or more DMRSs, and where the one or more shift values include a time shift value, a frequency shift value, or both.

In some examples, the assistance information component 1140 is capable of, configured to, or operable to support a means for transmitting, to a network entity, assistance information indicating a request for the DMRS adaptation pattern, where the indication of the DMRS adaptation pattern is received in response to the assistance information.

In some examples, in accordance with the DMRS adaptation pattern, the downlink channel excludes resource elements carrying a DMRS.

In some examples, the configuration component 1125 is capable of, configured to, or operable to support a means for receiving an indication of a unit of adaptation associated with the DMRS adaptation pattern, where the unit of adaptation includes a resource block, a physical resource group, or a sub-band.

In some examples, the indication of the DMRS adaptation pattern is received via an RRC message, a MAC-CE, DCI, SI, or a SSB.

In some examples, to support receiving the indication of the DMRS adaptation pattern, the configuration component 1125 is capable of, configured to, or operable to support a means for receiving an indication of an index of a lookup table, where the lookup table includes different DMRS adaptation patterns for different numerologies, frequency ranges, UE capabilities, or a combination thereof.

In some examples, the downlink channel includes a Rank-1 physical downlink shared channel or a physical downlink control channel.

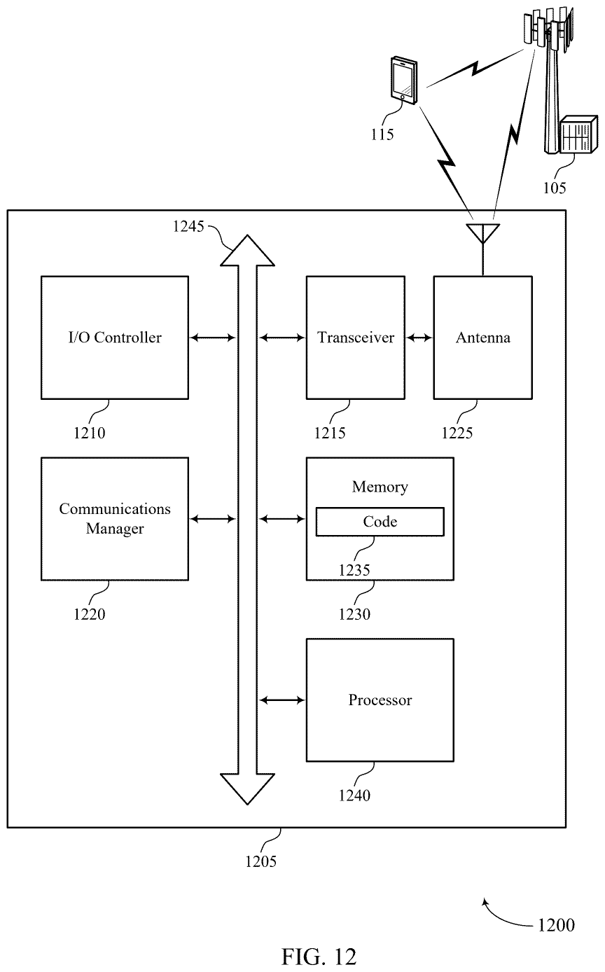

FIG. 12 shows a diagram of a system 1200 including a device 1205 that supports TRS reuse for channel estimation in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting TRS reuse for channel estimation). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving an indication of TRS reuse for channel estimation of a downlink channel and an indication of a DMRS adaptation pattern that is based on the TRS reuse. The communications manager 1220 is capable of, configured to, or operable to support a means for decoding, based on the TRS reuse for channel estimation, one or more resource elements associated with the downlink channel in accordance with the DMRS adaptation pattern, the one or more resource elements carrying one or more TRSs that are QCLed with the downlink channel. The communications manager 1220 is capable of, configured to, or operable to support a means for performing, based on the TRS reuse for channel estimation, a channel estimation procedure for the downlink channel using the one or more TRSs.

By including or configuring the communications manager 1220 in accordance with examples as described herein, the device 1205 may support techniques for improved communication reliability, more efficient utilization of communication resources, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of TRS reuse for channel estimation as described herein, or the at least one processor 1240 and the at least one memory 1230 may be otherwise configured to, individually or collectively, perform or support such operations.

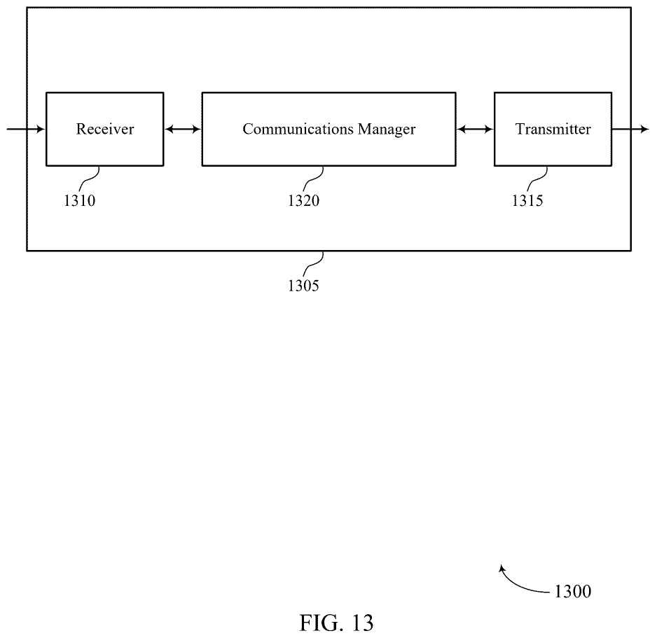

FIG. 13 shows a block diagram 1300 of a device 1305 that supports TRS reuse for channel estimation in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of TRS reuse for channel estimation as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting an indication of TRS reuse for channel estimation and an indication of a DMRS adaptation pattern. The communications manager 1320 is capable of, configured to, or operable to support a means for transmitting, in accordance with the DMRS adaptation pattern, a downlink channel including one or more resource elements carrying one or more TRSs that are QCLed with the downlink channel. The communications manager 1320 is capable of, configured to, or operable to support a means for receiving an indication of a channel estimation of the downlink channel that is based on the one or more resource elements carrying the one or more TRSs.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for more efficient utilization of communication resources.

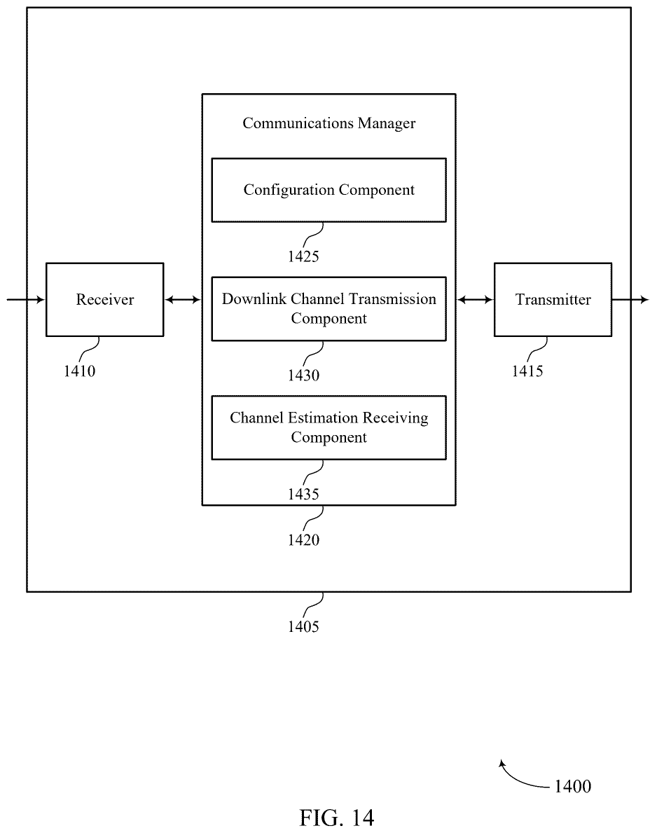

FIG. 14 shows a block diagram 1400 of a device 1405 that supports TRS reuse for channel estimation in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of TRS reuse for channel estimation as described herein. For example, the communications manager 1420 may include a configuration component 1425, a downlink channel transmission component 1430, a channel estimation receiving component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The configuration component 1425 is capable of, configured to, or operable to support a means for transmitting an indication of TRS reuse for channel estimation and an indication of a DMRS adaptation pattern. The downlink channel transmission component 1430 is capable of, configured to, or operable to support a means for transmitting, in accordance with the DMRS adaptation pattern, a downlink channel including one or more resource elements carrying one or more TRSs that are QCLed with the downlink channel. The channel estimation receiving component 1435 is capable of, configured to, or operable to support a means for receiving an indication of a channel estimation of the downlink channel that is based on the one or more resource elements carrying the one or more TRSs.

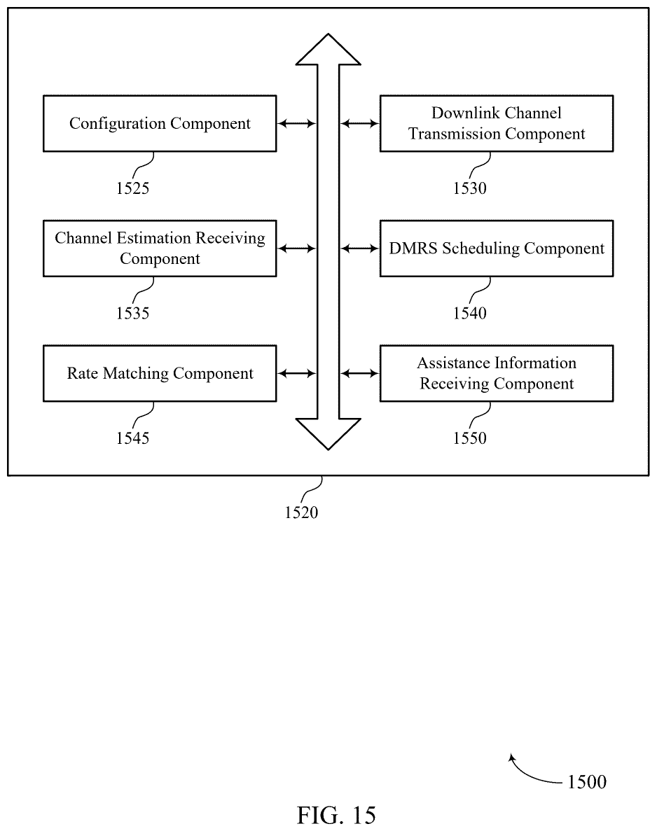

FIG. 15 shows a block diagram 1500 of a communications manager 1520 that supports TRS reuse for channel estimation in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of TRS reuse for channel estimation as described herein. For example, the communications manager 1520 may include a configuration component 1525, a downlink channel transmission component 1530, a channel estimation receiving component 1535, a DMRS scheduling component 1540, a rate matching component 1545, an assistance information receiving component 1550, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The configuration component 1525 is capable of, configured to, or operable to support a means for transmitting an indication of TRS reuse for channel estimation and an indication of a DMRS adaptation pattern. The downlink channel transmission component 1530 is capable of, configured to, or operable to support a means for transmitting, in accordance with the DMRS adaptation pattern, a downlink channel including one or more resource elements carrying one or more TRSs that are QCLed with the downlink channel. The channel estimation receiving component 1535 is capable of, configured to, or operable to support a means for receiving an indication of a channel estimation of the downlink channel that is based on the one or more resource elements carrying the one or more TRSs.

In some examples, the DMRS scheduling component 1540 is capable of, configured to, or operable to support a means for omitting, in accordance with the DMRS adaptation pattern, an originally-scheduled DMRS from the downlink channel. In some examples, the rate matching component 1545 is capable of, configured to, or operable to support a means for performing rate matching of downlink data into one or more resource elements associated with the originally-scheduled DMRS that do not overlap with the one or more resource elements carrying the one or more TRSs.

In some examples, in accordance with the DMRS adaptation pattern, the downlink channel further includes one or more second resource elements carrying one or more DMRSs.

In some examples, the one or more resource elements carrying the one or more TRSs and the one or more second resource elements carrying the one or more DMRSs are orthogonal.

In some examples, the one or more resource elements carrying the one or more TRSs and the one or more second resource elements carrying the one or more DMRSs partially overlap in a time domain, a frequency domain, or both.

In some examples, the one or more second resource elements carrying the one or more DMRSs are located outside of a coherence area associated with the one or more resource elements carrying the one or more TRSs.

In some examples, the coherence area is indicated by a first quantity of time units and a second quantity of resource elements. In some examples, the one or more resource elements carrying the one or more TRSs are centered within the coherence area.

In some examples, the configuration component 1525 is capable of, configured to, or operable to support a means for transmitting, to at least one UE, an indication of the coherence area, where the coherence area indicates a segment of time and frequency resources surrounding the one or more resource elements carrying the one or more TRSs over which a characteristic of the downlink channel is constant.

In some examples, to support transmitting the indication of the DMRS adaptation pattern, the configuration component 1525 is capable of, configured to, or operable to support a means for transmitting an indication of one or more shift values, where the one or more shift values indicate an offset, from a resource element originally-scheduled to carry the one or more DMRSs, of the one or more second resource elements carrying the one or more DMRSs, and where the one or more shift values include a time shift value, a frequency shift value, or both.

In some examples, to support transmitting the indication of the DMRS adaptation pattern, the configuration component 1525 is capable of, configured to, or operable to support a means for transmitting the indication of the DMRS adaptation pattern based on a channel quality associated with the downlink channel satisfying a threshold value.

In some examples, the assistance information receiving component 1550 is capable of, configured to, or operable to support a means for receiving, from a UE, assistance information indicating a request for the DMRS adaptation pattern, where the indication of the DMRS adaptation pattern is transmitted based on reception of the assistance information.

In some examples, the configuration component 1525 is capable of, configured to, or operable to support a means for transmitting an indication of a unit of adaptation associated with the DMRS adaptation pattern, where the unit of adaptation includes a resource block, a physical resource group, or a sub-band.

In some examples, the indication of the DMRS adaptation pattern is transmitted via an RRC message, a MAC-CE, DCI, SI, or a SSB.

In some examples, to support transmitting the indication of the DMRS adaptation pattern, the configuration component 1525 is capable of, configured to, or operable to support a means for transmitting an indication of an index of a lookup table, where the lookup table includes different DMRS adaptation patterns for different numerologies, frequency ranges, UE capabilities, or a combination thereof.

In some examples, the downlink channel includes a Rank-1 physical downlink shared channel or a physical downlink control channel.

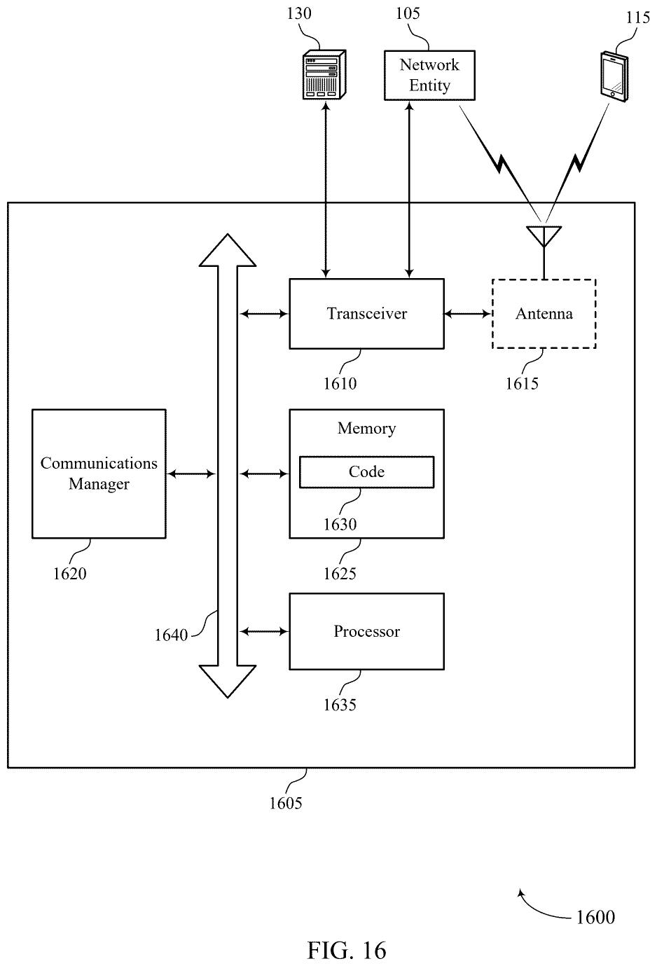

FIG. 16 shows a diagram of a system 1600 including a device 1605 that supports TRS reuse for channel estimation in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting TRS reuse for channel estimation). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting an indication of TRS reuse for channel estimation and an indication of a DMRS adaptation pattern. The communications manager 1620 is capable of, configured to, or operable to support a means for transmitting, in accordance with the DMRS adaptation pattern, a downlink channel including one or more resource elements carrying one or more TRSs that are QCLed with the downlink channel. The communications manager 1620 is capable of, configured to, or operable to support a means for receiving an indication of a channel estimation of the downlink channel that is based on the one or more resource elements carrying the one or more TRSs.

By including or configuring the communications manager 1620 in accordance with examples as described herein, the device 1605 may support techniques for improved communication reliability, more efficient utilization of communication resources, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of TRS reuse for channel estimation as described herein, or the at least one processor 1635 and the at least one memory 1625 may be otherwise configured to, individually or collectively, perform or support such operations.

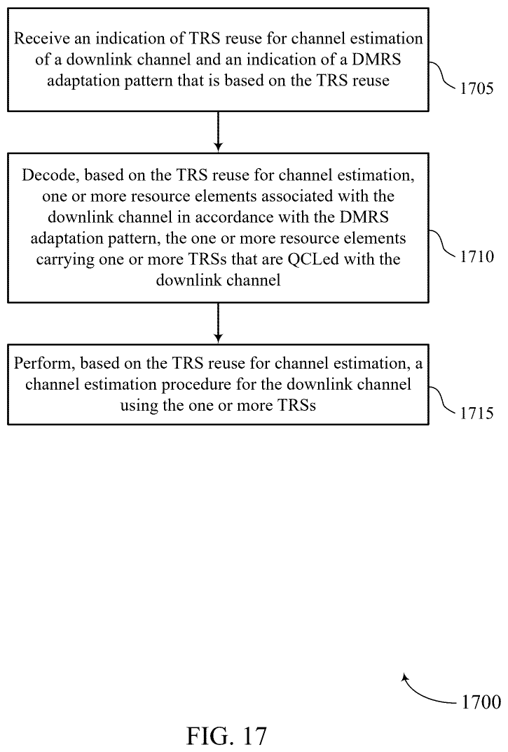

FIG. 17 shows a flowchart illustrating a method 1700 that supports TRS reuse for channel estimation in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving an indication of TRS reuse for channel estimation of a downlink channel and an indication of a DMRS adaptation pattern that is based on the TRS reuse. The operations of 1705 may be performed in accordance with examples as disclosed herein. In some examples, aspects of the operations of 1705 may be performed by a configuration component 1125 as described with reference to FIG. 11.

At 1710, the method may include decoding, based on the TRS reuse for channel estimation, one or more resource elements associated with the downlink channel in accordance with the DMRS adaptation pattern, the one or more resource elements carrying one or more TRSs that are QCLed with the downlink channel. The operations of 1710 may be performed in accordance with examples as disclosed herein. In some examples, aspects of the operations of 1710 may be performed by a decoding component 1130 as described with reference to FIG. 11.

At 1715, the method may include performing, based on the TRS reuse for channel estimation, a channel estimation procedure for the downlink channel using the one or more TRSs. The operations of 1715 may be performed in accordance with examples as disclosed herein. In some examples, aspects of the operations of 1715 may be performed by a channel estimation component 1135 as described with reference to FIG. 11.

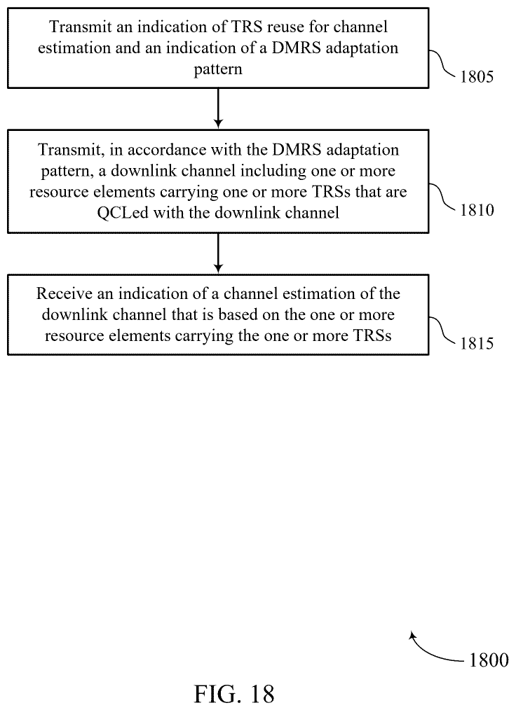

FIG. 18 shows a flowchart illustrating a method 1800 that supports TRS reuse for channel estimation in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include transmitting an indication of TRS reuse for channel estimation and an indication of a DMRS adaptation pattern. The operations of 1805 may be performed in accordance with examples as disclosed herein. In some examples, aspects of the operations of 1805 may be performed by a configuration component 1525 as described with reference to FIG. 15.

At 1810, the method may include transmitting, in accordance with the DMRS adaptation pattern, a downlink channel including one or more resource elements carrying one or more TRSs that are QCLed with the downlink channel. The operations of 1810 may be performed in accordance with examples as disclosed herein. In some examples, aspects of the operations of 1810 may be performed by a downlink channel transmission component 1530 as described with reference to FIG. 15.

At 1815, the method may include receiving an indication of a channel estimation of the downlink channel that is based on the one or more resource elements carrying the one or more TRSs. The operations of 1815 may be performed in accordance with examples as disclosed herein. In some examples, aspects of the operations of 1815 may be performed by a channel estimation receiving component 1535 as described with reference to FIG. 15.

The following provides an overview of aspects of the present disclosure:

Aspect 1: A method for wireless communications by a UE, comprising: receiving an indication of TRS reuse for channel estimation of a downlink channel and an indication of a DMRS adaptation pattern that is based at least in part on the TRS reuse; decoding, based at least in part on the TRS reuse for channel estimation, one or more resource elements associated with the downlink channel in accordance with the DMRS adaptation pattern, the one or more resource elements carrying one or more TRSs that are QCLed with the downlink channel; and performing, based at least in part on the TRS reuse for channel estimation, a channel estimation procedure for the downlink channel using the one or more TRSs.

Aspect 2: The method of aspect 1, further comprising: decoding one or more second resource elements associated with the downlink channel in accordance with the DMRS adaptation pattern, the one or more second resource elements carrying one or more DMRSs QCLed with the one or more TRSs, wherein the channel estimation procedure is performed using the one or more DMRSs.

Aspect 3: The method of aspect 2, wherein the one or more second resource elements carrying the one or more DMRSs are located outside of a coherence area associated with the one or more resource elements carrying the one or more TRSs.

Aspect 4: The method of aspect 3, wherein the coherence area is indicated by a first quantity of time units and a second quantity of resource elements, and the one or more resource elements carrying the one or more TRSs are centered within the coherence area.

Aspect 5: The method of any of aspects 3 through 4, further comprising: receiving, from a network entity, an indication of the coherence area, wherein the coherence area indicates a segment of time and frequency resources surrounding the one or more resource elements carrying the one or more TRSs.

Aspect 6: The method of any of aspects 2 through 5, wherein receiving the indication of the DMRS adaptation pattern comprises: receiving an indication of one or more shift values, wherein the one or more shift values indicate an offset, from a resource element originally-scheduled to carry the one or more DMRSs, of the one or more second resource elements carrying the one or more DMRSs, and wherein the one or more shift values include a time shift value, a frequency shift value, or both.

Aspect 7: The method of any of aspects 1 through 6, further comprising: transmitting, to a network entity, assistance information indicating a request for the DMRS adaptation pattern, wherein the indication of the DMRS adaptation pattern is received in response to the assistance information.

Aspect 8: The method of any of aspects 1 through 7, wherein in accordance with the DMRS adaptation pattern, the downlink channel excludes resource elements carrying a DMRS.

Aspect 9: The method of any of aspects 1 through 8, further comprising: receiving an indication of a unit of adaptation associated with the DMRS adaptation pattern, wherein the unit of adaptation includes a resource block, a physical resource group, or a sub-band.

Aspect 10: The method of any of aspects 1 through 9, wherein the indication of the DMRS adaptation pattern is received via an RRC message, a MAC-CE, DCI, SI, or an SSB.

Aspect 11: The method of any of aspects 1 through 10, wherein receiving the indication of the DMRS adaptation pattern comprises: receiving an indication of an index of a lookup table, wherein the lookup table comprises different DMRS adaptation patterns for different numerologies, frequency ranges, UE capabilities, or a combination thereof.

Aspect 12: The method of any of aspects 1 through 11, wherein the downlink channel comprises a rank-1 physical downlink shared channel or a physical downlink control channel.

Aspect 13: A method for wireless communications by a network entity, comprising: transmitting an indication of TRS reuse for channel estimation and an indication of a DMRS adaptation pattern; transmitting, in accordance with the DMRS adaptation pattern, a downlink channel comprising one or more resource elements carrying one or more TRSs that are QCLed with the downlink channel; and receiving an indication of a channel estimation of the downlink channel that is based at least in part on the one or more resource elements carrying the one or more TRSs.

Aspect 14: The method of aspect 13, further comprising: omitting, in accordance with the DMRS adaptation pattern, an originally-scheduled DMRS from the downlink channel; and performing rate matching of downlink data into one or more resource elements associated with the originally-scheduled DMRS that do not overlap with the one or more resource elements carrying the one or more TRSs.

Aspect 15: The method of any of aspects 13 through 14, wherein, in accordance with the DMRS adaptation pattern, the downlink channel further comprises one or more second resource elements carrying one or more DMRSs.

Aspect 16: The method of aspect 15, wherein the one or more resource elements carrying the one or more TRSs and the one or more second resource elements carrying the one or more DMRSs are orthogonal.

Aspect 17: The method of any of aspects 15 through 16, wherein the one or more resource elements carrying the one or more TRSs and the one or more second resource elements carrying the one or more DMRSs partially overlap in a time domain, a frequency domain, or both.

Aspect 18: The method of any of aspects 15 through 17, wherein the one or more second resource elements carrying the one or more DMRSs are located outside of a coherence area associated with the one or more resource elements carrying the one or more TRSs.

Aspect 19: The method of aspect 18, wherein the coherence area is indicated by a first quantity of time units and a second quantity of resource elements, and the one or more resource elements carrying the one or more TRSs are centered within the coherence area.

Aspect 20: The method of any of aspects 18 through 19, further comprising: transmitting, to at least one UE, an indication of the coherence area, wherein the coherence area indicates a segment of time and frequency resources surrounding the one or more resource elements carrying the one or more TRSs over which a characteristic of the downlink channel is constant.

Aspect 21: The method of any of aspects 15 through 20, wherein transmitting the indication of the DMRS adaptation pattern comprises: transmitting an indication of one or more shift values, wherein the one or more shift values indicate an offset, from a resource element originally-scheduled to carry the one or more DMRSs, of the one or more second resource elements carrying the one or more DMRSs, and wherein the one or more shift values include a time shift value, a frequency shift value, or both.

Aspect 22: The method of any of aspects 13 through 21, wherein transmitting the indication of the DMRS adaptation pattern comprises: transmitting the indication of the DMRS adaptation pattern based at least in part on a channel quality associated with the downlink channel satisfying a threshold value.

Aspect 23: The method of any of aspects 13 through 22, further comprising: receiving, from a UE, assistance information indicating a request for the DMRS adaptation pattern, wherein the indication of the DMRS adaptation pattern is transmitted based at least in part on reception of the assistance information.

Aspect 24: The method of any of aspects 13 through 23, further comprising: transmitting an indication of a unit of adaptation associated with the DMRS adaptation pattern, wherein the unit of adaptation includes a resource block, a physical resource group, or a sub-band.

Aspect 25: The method of any of aspects 13 through 24, wherein the indication of the DMRS adaptation pattern is transmitted via an RRC message, a MAC-CE, DCI, SI, or an SSB.

Aspect 26: The method of any of aspects 13 through 25, wherein transmitting the indication of the DMRS adaptation pattern comprises: transmitting an indication of an index of a lookup table, wherein the lookup table comprises different DMRS adaptation patterns for different numerologies, frequency ranges, UE capabilities, or a combination thereof.

Aspect 27: The method of any of aspects 13 through 26, wherein the downlink channel comprises a rank-1 physical downlink shared channel or a physical downlink control channel.

Aspect 28: A UE for wireless communications, comprising one or more memories storing processor-executable code, and one or more processors coupled with the one or more memories and individually or collectively operable to execute the code to cause the UE to perform a method of any of aspects 1 through 12.

Aspect 29: A UE for wireless communications, comprising at least one means for performing a method of any of aspects 1 through 12.

Aspect 30: A non-transitory computer-readable medium storing code for wireless communications, the code comprising instructions executable by one or more processors to perform a method of any of aspects 1 through 12.

Aspect 31: A network entity for wireless communications, comprising one or more memories storing processor-executable code, and one or more processors coupled with the one or more memories and individually or collectively operable to execute the code to cause the network entity to perform a method of any of aspects 13 through 27.

Aspect 32: A network entity for wireless communications, comprising at least one means for performing a method of any of aspects 13 through 27.

Aspect 33: A non-transitory computer-readable medium storing code for wireless communications, the code comprising instructions executable by one or more processors to perform a method of any of aspects 13 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of tracking reference signal (TRS) reuse for channel estimation of a downlink channel and an indication of a demodulation reference signal (DMRS) adaptation pattern that is based at least in part on the TRS reuse;
decode, based at least in part on the TRS reuse for channel estimation, one or more resource elements associated with the downlink channel in accordance with the DMRS adaptation pattern, the one or more resource elements carrying one or more TRSs that are quasi co-located (QCLed) with the downlink channel; and
perform, based at least in part on the TRS reuse for channel estimation, a channel estimation procedure for the downlink channel using the one or more TRSs.

2. The UE of claim 1, wherein the one or more processors are individually or collectively further operable to execute the code to cause the UE to:
decode one or more second resource elements associated with the downlink channel in accordance with the DMRS adaptation pattern, the one or more second resource elements carrying one or more DMRSs QCLed with the one or more TRSs, wherein the channel estimation procedure is performed using the one or more DMRSs.

3. The UE of claim 2, wherein the one or more second resource elements carrying the one or more DMRSs are located outside of a coherence area associated with the one or more resource elements carrying the one or more TRSs.

4. The UE of claim 3, wherein:
the coherence area is indicated by a first quantity of time units and a second quantity of resource elements, and
the one or more resource elements carrying the one or more TRSs are centered within the coherence area.

5. The UE of claim 3, wherein the one or more processors are individually or collectively further operable to execute the code to cause the UE to:
receive, from a network entity, an indication of the coherence area, wherein the coherence area indicates a segment of time and frequency resources surrounding the one or more resource elements carrying the one or more TRSs.

6. The UE of claim 2, wherein, to receive the indication of the DMRS adaptation pattern, the one or more processors are individually or collectively operable to execute the code to cause the UE to:
receive an indication of one or more shift values, wherein the one or more shift values indicate an offset, from a resource element originally-scheduled to carry the one or more DMRSs, of the one or more second resource elements carrying the one or more DMRSs, and wherein the one or more shift values include a time shift value, a frequency shift value, or both.

7. The UE of claim 1, wherein the one or more processors are individually or collectively further operable to execute the code to cause the UE to:
transmit, to a network entity, assistance information indicating a request for the DMRS adaptation pattern, wherein the indication of the DMRS adaptation pattern is received in response to the assistance information.

8. The UE of claim 1, wherein in accordance with the DMRS adaptation pattern, the downlink channel excludes resource elements carrying a DMRS.

9. The UE of claim 1, wherein the one or more processors are individually or collectively further operable to execute the code to cause the UE to:
receive an indication of a unit of adaptation associated with the DMRS adaptation pattern, wherein the unit of adaptation includes a resource block, a physical resource group, or a sub-band.

10. The UE of claim 1, wherein the indication of the DMRS adaptation pattern is received via a radio resource control (RRC) message, a medium access control-control element (MAC-CE), downlink control information (DCI), system information (SI), or a synchronization signal block (SSB).

11. The UE of claim 1, wherein, to receive the indication of the DMRS adaptation pattern, the one or more processors are individually or collectively operable to execute the code to cause the UE to:
receive an indication of an index of a lookup table, wherein the lookup table comprises different DMRS adaptation patterns for different numerologies, frequency ranges, UE capabilities, or a combination thereof.

12. The UE of claim 1, wherein the downlink channel comprises a rank-1 physical downlink shared channel or a physical downlink control channel.

13. A network entity, comprising:
one or more memories storing processor-executable code; and
one or more processors coupled with the one or more memories and individually or collectively operable to execute the code to cause the network entity to:
transmit an indication of tracking reference signal (TRS) reuse for channel estimation and an indication of a demodulation reference signal (DMRS) adaptation pattern;
transmit, in accordance with the DMRS adaptation pattern, a downlink channel comprising one or more resource elements carrying one or more TRSs that are quasi co-located (QCLed) with the downlink channel; and
receive an indication of a channel estimation of the downlink channel that is based at least in part on the one or more resource elements carrying the one or more TRSs.

14. The network entity of claim 13, wherein the one or more processors are individually or collectively further operable to execute the code to cause the network entity to:
omit, in accordance with the DMRS adaptation pattern, an originally-scheduled DMRS from the downlink channel; and
perform rate matching of downlink data into one or more resource elements associated with the originally-scheduled DMRS that do not overlap with the one or more resource elements carrying the one or more TRSs.

15. The network entity of claim 13, wherein in accordance with the DMRS adaptation pattern, the downlink channel further comprises one or more second resource elements carrying one or more DMRSs.

16. The network entity of claim 15, wherein the one or more resource elements carrying the one or more TRSs and the one or more second resource elements carrying the one or more DMRSs are orthogonal.

17. The network entity of claim 15, wherein the one or more resource elements carrying the one or more TRSs and the one or more second resource elements carrying the one or more DMRSs partially overlap in a time domain, a frequency domain, or both.

18. The network entity of claim 15, wherein the one or more second resource elements carrying the one or more DMRSs are located outside of a coherence area associated with the one or more resource elements carrying the one or more TRSs.

19. The network entity of claim 18, wherein:
the coherence area is indicated by a first quantity of time units and a second quantity of resource elements, and
the one or more resource elements carrying the one or more TRSs are centered within the coherence area.

20. The network entity of claim 18, wherein the one or more processors are individually or collectively further operable to execute the code to cause the network entity to:
transmit, to at least one user equipment (UE), an indication of the coherence area, wherein the coherence area indicates a segment of time and frequency resources surrounding the one or more resource elements carrying the one or more TRSs over which a characteristic of the downlink channel is constant.

21. The network entity of claim 15, wherein, to transmit the indication of the DMRS adaptation pattern, the one or more processors are individually or collectively operable to execute the code to cause the network entity to:
transmit an indication of one or more shift values, wherein the one or more shift values indicate an offset, from a resource element originally-scheduled to carry the one or more DMRSs, of the one or more second resource elements carrying the one or more DMRSs, and wherein the one or more shift values include a time shift value, a frequency shift value, or both.

22. The network entity of claim 13, wherein, to transmit the indication of the DMRS adaptation pattern, the one or more processors are individually or collectively operable to execute the code to cause the network entity to:
transmit the indication of the DMRS adaptation pattern based at least in part on a channel quality associated with the downlink channel satisfying a threshold value.

23. The network entity of claim 13, wherein the one or more processors are individually or collectively further operable to execute the code to cause the network entity to:
receive, from a user equipment (UE), assistance information indicating a request for the DMRS adaptation pattern, wherein the indication of the DMRS adaptation pattern is transmitted based at least in part on reception of the assistance information.

24. The network entity of claim 13, wherein the one or more processors are individually or collectively further operable to execute the code to cause the network entity to:
transmit an indication of a unit of adaptation associated with the DMRS adaptation pattern, wherein the unit of adaptation includes a resource block, a physical resource group, or a sub-band.

25. The network entity of claim 13, wherein the indication of the DMRS adaptation pattern is transmitted via a radio resource control (RRC) message, a medium access control-control element (MAC-CE), downlink control information (DCI), system information (SI), or a synchronization signal block (SSB).

26. The network entity of claim 13, wherein, to transmit the indication of the DMRS adaptation pattern, the one or more processors are individually or collectively operable to execute the code to cause the network entity to:
transmit an indication of an index of a lookup table, wherein the lookup table comprises different DMRS adaptation patterns for different numerologies, frequency ranges, UE capabilities, or a combination thereof.

27. The network entity of claim 13, wherein the downlink channel comprises a rank-1 physical downlink shared channel or a physical downlink control channel.

28. A method for wireless communications by a user equipment (UE), comprising:
receiving an indication of tracking reference signal (TRS) reuse for channel estimation of a downlink channel and an indication of a demodulation reference signal (DMRS) adaptation pattern that is based at least in part on the TRS reuse;
decoding, based at least in part on the TRS reuse for channel estimation, one or more resource elements associated with the downlink channel in accordance with the DMRS adaptation pattern, the one or more resource elements carrying one or more TRSs that are quasi co-located (QCLed) with the downlink channel; and
performing, based at least in part on the TRS reuse for channel estimation, a channel estimation procedure for the downlink channel using the one or more TRSs.

29. The method of claim 28, further comprising:
decoding one or more second resource elements associated with the downlink channel in accordance with the DMRS adaptation pattern, the one or more second resource elements carrying one or more DMRSs QCLed with the one or more TRSs, wherein the channel estimation procedure is performed using the one or more DMRSs.

30. A method for wireless communications by a network entity, comprising:
transmitting an indication of tracking reference signal (TRS) reuse for channel estimation and an indication of a demodulation reference signal (DMRS) adaptation pattern;
transmitting, in accordance with the DMRS adaptation pattern, a downlink channel comprising one or more resource elements carrying one or more TRSs that are quasi co-located (QCLed) with the downlink channel; and
receiving an indication of a channel estimation of the downlink channel that is based at least in part on the one or more resource elements carrying the one or more TRSs.
